(19) United States
(12) Patent Application Publication
(10) Pub. No.: US 2012/0246139 A1
(43) Pub. Date: Sep. 27, 2012

(54) SYSTEM AND METHOD FOR RESUME, YEARBOOK AND REPORT GENERATION BASED ON WEBCRAWLING AND SPECIALIZED DATA COLLECTION

(76) Inventor: BINDU RAMA RAO, Laguna Niguel, CA (US)

(21) Appl. No.: 13/492,799

(22) Filed: Jun. 8, 2012

Related U.S. Application Data
(63) Continuation-in-part of application No. 12/925,417, filed on Oct. 21, 2010.

(51) Int. Cl. G06F 17/30

(52) U.S. Cl. 707/709; 707/E17.108

(57) ABSTRACT

A website system collecting specialized data on users and organizations from a web crawler. The website system receives from a user a search string (via a search webpage provided by the website for example) with a request to create a technology overview and research report with recent updates and research information in the field for a user specified technology/subject area. It creates a technology overview and research report and presents it. Similarly, it creates user profiles, yearbooks, resumes, etc. based on the specialized data collected from web crawling.

### CROSS REFERENCES TO RELATED APPLICATIONS

The present patent application is a continuation-in-parts (CIP) of, makes reference to, claims priority to, and claims benefit of U.S. non-Provisional application Ser. No. 12/925,417 entitled AUTOMATED BLOGGING AND SKILLS PORTFOLIO MANAGEMENT SYSTEM (Attorney Docket No. BRRSDJ01201U1) filed on Oct. 21, 2010, the complete subject matter of which is hereby incorporated herein by reference, in its entirety.

### BACKGROUND

1. Technical Field

The present invention relates generally to the web crawling, and more specifically to the ability to collect specialized data and create automated resumes, yearbooks and reports.

2. Related Art

Currently, searches on the Internet, and more specifically on the World Wide Web, are performed by users using a number of commercial search engines. These search engines are accessed at various web sites maintained by the operators of the search engines. Typically, to perform a search the user will enter terms to be searched into a form, and may also make selections from pull-down menus and checkboxes, to enter a search request on a search engine's web site. Then, the search engine will return a listing of web sites that contain the entered terms.

Search engines perform many complex tasks which can be generally categorized as front-end and back-end tasks. For example, when the user enters the terms and executes a search, the search engine service does not immediately search the Internet or World Wide Web for web sites containing data matching the search terms. This method would be slow and cumbersome given the huge number of web site that must be searched in order to find potential matches. Instead, the search engine service will search its own internal database of cataloged terms and corresponding web sites to find matches for the entered terms. The process of accepting the user's input, searching the internal database, and displaying the results for the user would be examples of front end tasks.

However, the search engine must perform back-end tasks unseen by the user in order to create and maintain its database of terms and corresponding web sites. These back-end tasks include searching for common terms on the Internet or World Wide Web, and cataloging their locations in the search engine's internal database so that the data can be provided quickly and efficiently to users in response to a search request.

Among the devices used by search engines to find data on the Internet and the World Wide Web are robots, crawlers, and spiders. Crawlers, spiders, and robots all work in a similar manner. These devices start by issuing a hyperlink request to a web site of interest. A hyperlink request contains a Uniform Resource Locator, or URL which indicates the address to a particular web page containing data. In response to the hyperlink request, the web site will send data back to the crawler. This data may be Hyper Text Markup Language pages, known as HTML pages, or other documents. Once the crawler has received an HTML page, it will look for other hyperlinks contained within the HTML page itself. These new hyperlinks will be indexed and cataloged in the search engines database. Then the crawler will follow the new hyperlinks and repeat the process, collecting more hyperlinks.

A web crawler typically methodically scans or “crawls” through Internet pages to create an index of the data it's looking for. Alternative names for a web crawler include web spider, web robot, bot, crawler, and automatic indexer. On problem with web crawlers is that they are incapable for searching for and flagging specific categories of data they encounter, and of collecting specific types of webpage content as specified by a user. If a user wants to automatically collect data regarding a new technological innovation, or a new product of interest, there is no easy way for a web crawler to meet the user's requirements, and provide what the user wants.

One major issue with search engines is that they are not capable of automatically organizing data that it searches in formats more useful to a user. Users would like to automatically receive reports of data that are likely to interest them. Users would like to receive newsletter of recent research in subjects that interest them, but there is no easy way for search engines to deliver that. Users might want to automatically receive a newly updated/newly assembled profile of a friend or acquaintance, but there are no easy way/no available products that help determine that. Users may want to receive information on organization that conduct a particular type of research on a particular technology, but the user has no way to get a report assembled for him that provides such information, in an adhoc manner. A user might want to automatically generate a rough draft of his resume, without having to painfully collect information first, but there is no service or easy means to get such a draft resume assembled automatically today.

Users sometimes have a need to create a resume or a user profile of themselves or of another person. Often, this requires digging up old information, typing them into a word processor on a laptop, etc. Such time consuming activities are often performed several times a year. Users have no easy/automated way to create resumes and user profiles.

Often users need to research a area of technology to keep up with recent developments. They buy journals and magazines to peruse for that purpose, which is not an inexpensive proposition—technical journals and trade magazines cost a lot and keeping up to date with technology or areas of interest to a user is quite a time consuming task requiring searching on the Internet as well as a expensive activity if one were to buy a number of magazines and journals frequently.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a website system that combines the power of a web crawler with the flexibility of a custom report generator that automatically collects data of interest under various categories and produces customized reports of interest to a user.

FIG. 2 is a perspective block diagram of a web crawler communicative coupled to a website system that collects user data from the Internet webpages as it crawls the Internet, stores it in a database, and facilitates creation of a resume or a user profile based on the stored data in the database.

FIG. 3 is a flow chart of an exemplary operation of the website system.

FIG. 4 is a perspective block diagram of an exemplary webpage/search screen that a user employs to provide a search string, request an annual publication, a profile, a resume or a research overview, provide dates selectively, conduct a search, receive results from multiple result sets that is displayed in a combined results page.

### DETAILED DESCRIPTION OF THE DRAWINGS

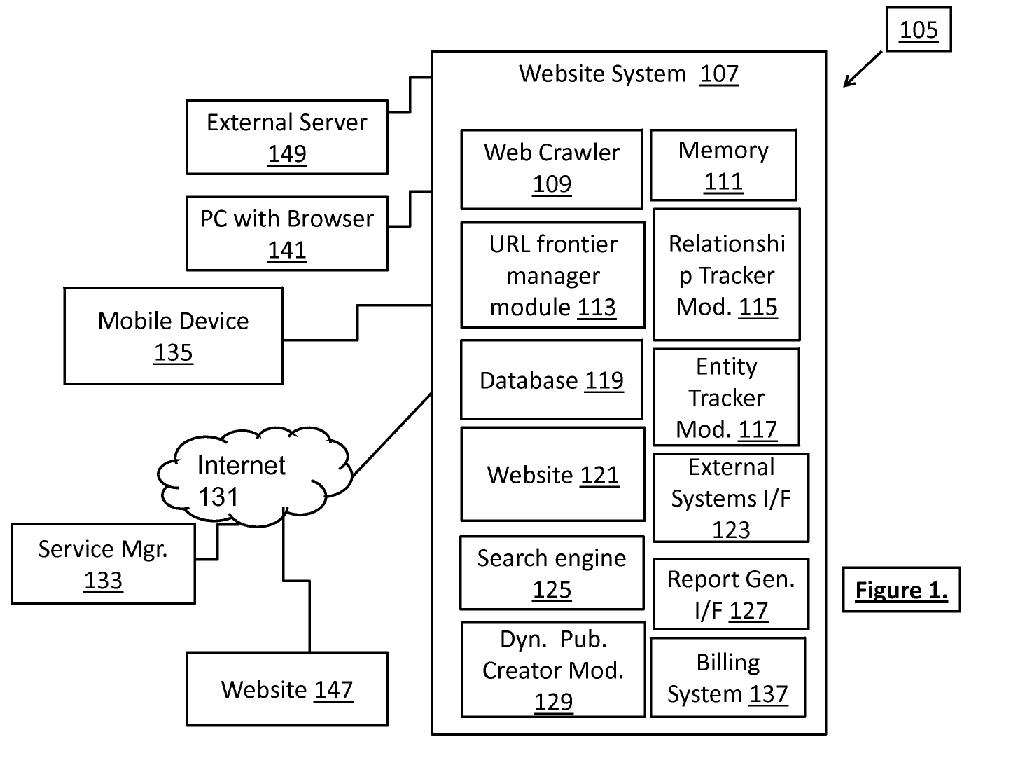

FIG. 1 is a perspective block diagram of a website system 107 that combines the power of a web crawler with the flexibility of a custom report generator that automatically collects data of interest under various categories and produces customized reports of interest to a user. The website system 107 comprises a web crawler 109 that crawls webpages starting with seed URLs, and crawls links and references contained in those webpages, and gathers a URL frontier. A URL frontier manager module 113 manages the URL frontier. The web crawler 109 visits the URLs from the URL frontier recursively according to a set of policies and gathers a crawled data, wherein the crawled data also comprises information about one or more entities mentioned or referenced in the webpages crawled. A relationship tracker module 115 creates a network of relationships from the crawled data and tracks relationships between the one or more entities (such as people, organizations, etc.).

The website system 107 collects specialized data on users and organizations from the web crawler 109. The website system 107 receives from a user a search string (via a search webpage provided by a website 121, for example) with a request to create a technology overview and research report with recent updates and research information in the field for a user specified technology/subject area. It creates a technology overview and research report and presents it. Similarly, it creates user profiles, yearbooks, resumes based on the specialized data collected from web crawling by the web crawler 109.

The relationship tracker module 115 determines the dates of relationships, duration of those relationships, the category and type of those relationships and storing them as searchable data in a database 119. An entity tracker module 117 collects and tracks details of the one or more entities, the details comprising activities associated with the one or more entities, and modifications to those details over time, and stores them in the database 119. The website system 107, when triggered, provides a report related to one of the one or more entities, a report of relationships over time for a given entity among the one or more entities, or a report of activities associated with the given entity specified.

The basic set of features supported by the web crawler 109 is the creation and management of a URL frontier. It takes a list of seed URLs as its input and repeatedly executes the following steps. Remove a URL from the URL list, determine the IP address of its host name, download the corresponding document, process it and note items of interest (save items of interest optionally) and extract any links contained in it. For each of the extracted links, ensure that it is an absolute URL (derelativizing it if necessary), and add it to the list of URLs to download, provided it has not been encountered before. If desired, process the downloaded document in other ways (e.g., index its content, note if it is a research paper associated with a technology, a resume, a product information, a transcript, a record of achievement, a patent, etc.). This basic features are implemented employing a number of functional components:
the URL frontier manager module 113 for storing the list of URLs to download;
name resolution module associated with the web crawler 109 to convert host names into IP addresses and vice versa, as needed;
the external systems interface 123 also used for downloading documents using the HTTP protocol (or other protocols, as applicable)
a link and references extraction module of the web crawler 109 for extracting links from HTML documents; and
a link tracker module of the web crawler 109 for determining whether a URL has been encountered before.

The web crawler 109 is one type of bot, or software agent in one embodiment. In general, it starts with a list of URLs to visit, called the seeds. As the web crawler 109 visits these URLs, it identifies all the hyperlinks in the page and adds them to the list of URLs to visit, called the crawl frontier or URL frontier. URLs from the frontier are recursively visited according to a set of policies.

The behavior of a Web crawler is the outcome of a combination of policies:
a selection policy that states which pages to download and which category of webpage content are of interest or are of a higher priority,
a re-visit policy that states when to check for changes to the pages,
a politeness policy that states how to avoid overloading Web sites, how to avoid accessing webpages that are prohibited by a website, etc., and
a parallelization policy that states how to coordinate distributed Web crawlers, wherein multiple threads are used to access different webpages simultaneously, to make webpage access more efficient and to increase throughput.

The activities supported by the website system 107 as part of data collection (as different categories of webpages are encountered) include document navigation, data downloading, document parsing, collection of relevant data from the webpages, categorizing the data from the webpages and flagging ones of special interest, breath-first traversal of the web starting with the seed URLs, etc. As part of being polite to websites, multiple requests are made in parallel, bundling multiple HTTP requests pending to the same server/website.

The web crawler 107 implements a “Robots Exclusion Protocol” that requires a web crawler 109 to fetch a special document containing these declarations from a web site before downloading any real content from it. To avoid downloading this file on every request, a HTTP protocol module maintains a fixed-sized cache mapping host names to their robots exclusion rules.

In one embodiment, the website system 107 collects rating feedback, a preference feedback, an audio feedback, a video feedback, an image feedback, and a text feedback provided by users on the Internet, for various products and services. It then makes it possible for a user, employing a product search webpage(s) provided by a website associated with, or provided by, the website system 107 to create a report of product feedbacks and ratings information, etc. For example, the user could, employing the product search webpage of the website 121 of the website system 107, specify a product search string “Panasonic Viera 47 inch HD TV” and receive a report, created in an adhoc manner for example, that provides not only one or more of a plurality of reviews, rating feedback, preference feedback, audio feedback, video feedback, an image feedback, and textual feedback provided by users on the Internet. In a related embodiment, these ratings, reviews, feedbacks, etc. are each presented in their user respective display sections on a webpage. In another related embodiment, these ratings, reviews, feedbacks, etc. are in addition to product information from the manufacturer and product sale information from one or more vendors on the Internet.

In one related embodiment, the same webpage/downloaded document is processed by multiple processing modules, one for determining names of people and organizations, another to detect products and services, a third for detecting details around images and videos so as to associated them with those details, etc.

The web crawler 109 implements a content-seen test to avoid downloading and processing the same webpage content multiple times, even if different websites provide them. It maintains a data structure called the document fingerprint set that stores a 64-bit checksum of the contents of each downloaded document wherein the fingerprint is derived from a checksum, such as a checksum computed using Broder's implementation of Rabin's fingerprinting algorithm, etc. Fingerprints offer provably strong probabilistic guarantees that two different strings will not have the same fingerprint.

The website system 107 is capable of multiprocessing employing multiple threads. For downloading webpages from different websites on the Internet, it selectively employs one of at least two approaches—single-threaded crawling processes and asynchronous I/O to perform multiple downloads in parallel or using a multi-threaded process in which each thread performs synchronous I/O.

There are many different uses for a web crawler 109 in the website system 107. It is used to collect data of interest and references to, or identification of, data of interest as crawling of webpages is conducted. It is also used to support search engine 125, which uses the web crawler 109 to collect information about what is available on public web pages. The web crawler 109 is also used to collect data on research topics, user profiles, user relationships with organizations, organizational interactions with employees, organizational relationships with product in the market, customer relationship with organizations, customer reviews of products and services, etc. Such collected data is used when Internet surfers, using the website 121 for example, enter a search term on the website 121, to access reports generated, or access to information retrieved from relevant web sites.

Images in webpages encountered during crawling by the web crawler 109 aren't the only files that most crawlers will find useless, and they should not be downloaded unless necessary or unless determined to be associated with a user, an organization, a product, a technology, or of interest to some user. Similarly, images, audio, video, compressed archives, PDFs, executables, and many more items that might be of interest to users are located, indexed and referenced in reports generated.

The website 121 is used by users to conduct an operation on a report or an annual publication that is presented to a user (such as after a search conducted by a user). The operation is a combination of at least one or more actions from the set of actions comprising editing, updating, modifying, customizing, sharing, storing, downloading, printing, emailing and retrieving the annual publication. The website 121 supports requesting, editing, updating, modifying, storing and sharing the annual publication that may be generated by a user, such as an annual report of documents published by a user, or an annual report of properties sold by a real estate agent, etc Annual publications are created, based on requests received or based on schedule or subscriptions, and is a yearbook for a school, an educational institution such as a university, a corporation, a local business, or for a social group (such as a group in Facebook or on LinkedIn), etc.

The website system 107 supports a method of operating a website that comprises the following steps:

Assembling a database of people and organization information by crawling to multiple websites;

Soliciting a user input, receiving the user request in response to the solicitation, and processing the user request (for example, a user request comprises a report type, a given year and a given organization);

Creating an automated yearbook in response to the user request, employing the database, among other sources of information;

Storing selectively the yearbook created;

Customizing the yearbook created, based on user specification; and

Sharing selectively the yearbook created.

The user request received from a user comprises a given year specification and a given organization specification. In one embodiment, it also comprises a report type (such as a research report, a yearbook, a resume, etc.). For example, the user might provide 2001 for a year of interest and Lucent as an organization, and specify a yearbook as a report type. The operation of assembling the database of people and organization involves accessing a website of potential interest, the website having a plurality of webpages. It also involves determining a subset of the plurality of webpages to process, and, for each webpage in the subset, enabling extraction of people and organization information from the webpage. This is followed by storing people and organization information in a database. Accessing websites comprises determining whether a given website has previously been accessed for searching for people and organization information, thereby avoiding unnecessary visits to websites that are not likely to change its content too quickly.

Creating an automated yearbook comprises the steps of finding target people information for people in the database who had one or more types of associations with the given organization in a given year (employing at least the database), and organizing the target people information and relationships of those people with organizations and activities within the given year. Then the target people information is enhanced to create an updated target people information, using other data that is retrieved from one or more external websites, servers, or social networks. Finally, the target people information is organized in a default format for presenting it to the user.

The yearbook document is presented in a format that can be saved, printed or stored, as necessary, by the user.

In one embodiment, the website system 107 supports entities wherein the entities comprises organizations, such as an organization selected by a user. Thus, the one or more entities that the web crawler collects data for comprises an organization (such as a commercial business or a high tech firm). The entity tracker module 117 collects and tracks details of the organization, the details comprising activities associated with the organization, and modifications to the details of the organization. Thus, details of the organization over time are collected and stored. The website system 107, when triggered, provides a report of relationships over time for the organization, wherein such relationships are with some of the other entities, such as people who are employees in that organization, or other organizations that are partners.

In another embodiment, the one or more entities for which data is collected, tracked and managed comprise references to and/or identification of one or more organizations and a person. The entity tracker module 117 collects and tracks details of the one or more organizations and the person (identified by a user, for example, via a webpage provided by the website 121). The entity tracker module 117 collects and tracks modifications to the details of the one or more organizations and the person. The website system 107, when triggered, provides a report of relationships over time for the person with at least one of the one or more organizations. For example, a draft resume is created and presented that comprises a list of all organization where a given individual (identified programmatically or specified by a user) has worked or has been associated with.

The website system 107 provides a search interface that facilitates search and retrieval of data collected and managed by the relationship tracker module and the entity tracker module. Specifically, in one embodiment, the website 121 provides webpages for searching, with the search engine 125 providing searching facilities and the webcrawler 109 providing crawled data for making the search engine effective.

The website system 107 collects data while crawling for one or more entities, wherein the one or more entities comprises references to and/or identification of one or more people and one or more organizations. The dynamic publication creator module 129 dynamically creates an annual publication providing a people information, an events information, an activities information and related data for a given year (user specified for example) in a target organization among the one or more organizations, based at least partially on the data in the database 119. For example, the web system 107, while crawling over websites 147 on the Internet encounters an organization named AT&T and a user named John Smith and identifies them as an organization and an individual, respectively, and collects related data about them and stores them in the database 119. The website system 107 selectively charges fees for presenting or communicating the annual publication. Alternatively, it provides a subscription service (paid or free, as necessary) that provides all kinds of report on demand to the user.

In a related embodiment, the website system 107, upon receiving a request that specifies the given year and the target organization, creates an annual publication employing the dynamic publication creator module 129 and presents it employing webpages in the website 121 or communicates it through email. A yearbook that is published dynamically by the web system 107 when given a user identification (such as a name) and an organization identification (such as a name of a high school) is a high school yearbook containing photographs of the senior class associated with the user identification in a school or college corresponding to the organization identification, and details of school activities in the previous year (or the year specified by user)

A yearbook that is also published dynamically by the web system 107, facilitated by the dynamic publication creator module 129, is one of an annual publication giving current information and listing events or aspects of the previous year, esp. in a particular field, such as wireless cellular mobile devices, or Wifi technologies, etc.

Thus, the present invention facilitates automated generation and publication of a yearbook for a user, based on data collected by crawling the Internet, given an organization identification (current year assumed), or an organization identification and a specific year. Such yearbooks generated records, highlights, and commemorates the past year of a a specified organization, such as school. The present invention also generates a yearbook for specific technologies, that is similar to a yearbook published annually for that specified technology by traditional book publishing means. Specifically, the current invention makes it possible to automatically generate/publish yearbooks for high schools, most colleges and many elementary and middle schools. The published yearbooks for an organization that is a school or college covers (based on a configuration setting, which is also provided a default configuration setting) a wide variety of topics from academics, student life, sports and other major events. Generally, each student is pictured with their class and each school organization (within the school) is usually pictured. It also generates/publishes a book of statistics or facts published annually for various organizations and technologies, and even creates a user-specific yearbook capturing events and data/photos/achievements for a given user within a given year duration.

In one embodiment, the website system 107 automatically collects by crawling, and generates when triggered, for different countries and different regions of the world, an automated yearbook that comprises:

Outstanding Achievers and Important Events in that country or region of the world

Year at a Glance—overview

Topics of the Year—main categories of news

Exploring the Universe—discoveries and new theories in astronomy and astro physics
The World We Live In—report on major problems, disasters, discoveries, environmental issues, etc.
UN & International Organisations—world wide bodies and their interactions and achievements

Fundamentals of Science

Basic General Knowledge
Our Country—additional data and information on recent events in that country/region
Sports and Games—regional and national sports coverage
Who's Who—the movers and the shakers and what they have been up to

The website system 107 facilitates the annual publication of various kinds of yearbooks, such as yearbooks for different regions/countries in the world, yearbooks for sports organization, yearbooks for technology areas, yearbooks for various schools and colleges, etc. In one embodiment, the yearbooks automatically published by the website system 107 are a draft version which individuals can customize, edit, modify and create their own versions, save it, print it, download it and pay for it. In a related embodiment, the user can request access to a copy of the automatically published yearbook, pay for customizing it with the help of the billing system 137, customize it, save a local copy or save a copy at the website 121, download a customized version if necessary, and the share it with others.

In one embodiment, the website system 107 supports crawling and collection of data for one or more entities wherein the one or more entities comprises one or more educational institutions and one or more individuals who are students in those educational institutions. The website 107 collects data on relationships over time between the entities (the educational institutions and the students, for example). The report of relationships over time, developed based on user requests, based on configuration of the website system 107, based on policies, based on subscriptions of users, etc. is a yearbook for the one or more individuals.

In a related embodiment, when the one or more entities for which the website system 107 collects data after crawling websites comprises one or more commercial or business organizations, and one or more individuals who were at some point employees or workers in those one or more commercial or business organizations. For example, the website system 107, when configured to do so, collects and tracks company and their employees over time, collect data on relationships between employees and companies as it evolves over time, and facilitates creation of a yearbook for the organization as well as a resume for any of the employees.

In a different embodiment, relationships over time that the website system 107 collects and maintains for the various entities it encounters during its crawling of websites also comprises activities and events over time. The relationships over time, the activities and events data are stored in the database 119. Based on this data in the database 119, a report is created (a requested by a user or based on policies or schedules) and presented as a webpage or in an email. In a related embodiment, the report is organized as one of a resume, a newsletter published by an educational institution, a bibliography, a newspaper, a publication from a school district, a product review, a sports statistics publication, a research paper on a topic, and a student graduation related document.

The entity tracker module 117 also collects and tracks documents associated with the one or more entities and stores references to those documents. It helps collect data encountered that relate to various entities, to various categories of entities. It facilitates reporting profiles of entities from collected data. It facilitates creation of a yearbook for the entity, employing all the available data and relationships associated with the entity, over a given duration. If a user triggered reporting request or a schedule driven reporting request is received by the website system 107, the report created by the website system 107 incorporates relevant information about the relevant entities, and it also incorporates at least a portion of the documents or references to the documents that are stored in the database that are associated with the relevant entities.

The website system 107 facilitates creation of an annual publication, such as a yearbook. It also facilitates automatic generation of a profile of at least one of the one or more organizations for a given year, for which the website system 107 has collected data.

In one embodiment, the one or more entities for which the website system 107 collects data while crawling (or entities encountered by crawling) comprises one or more individuals and the one or more organizations. The search engine 125 uses the web crawler 109 to collect information on the one or more individuals and the one or more organizations (or alternatively, the search engine employs data collected by the web crawler 109 as it crawls the Internet). The website system 107 provides webpages on the website 121 to permit users on the Internet 131 to enter a search term in order to retrieve details regarding the at least one of the individuals or the organizations. In response to the search terms provided by the user, the search engine runs one or more queries on the database 119 (and also uses external servers and databases as necessary), retrieves the search results—which may be organized in categories and provided in multiple sets or search result groups, and presents them to the user.

In a related embodiment, wherein the entities comprises one or more individuals, the website system 107 provides an interface, such as the external systems interface 123, to automatically create a resume or a user profile based on the crawled data and the data in the database 119, for at least one of the one or more individuals. Such automatic creation of a resume or user profile may also be scheduled, or triggered by a user request provided by a user from an appropriate web page presented to the user by the website 121.

In one embodiment, the website system 107 receives from a user a search string (via a search webpage provided by the website 121 for example) with a request to (from an appropriate button on the search webpage for example) to create a yearbook for a corporation. The website system 107 creates the yearbook that comprises summary of, or references to all research papers and technical documents published (or URLs of websites, ISBN numbers, titles, etc. to such research papers and technical documents), all patents filed for and acquired by the user specified corporation, details of personnel changes, market share information, products and services introduced into market, products and services terminated, etc.

In another embodiment, the website system 107 receives from a user a search string (via a search webpage provided by the website 121 for example) with a request to (from an appropriate button on the search webpage for example) to create a technology overview and research report with recent updates and research information in the field for a user specified technology/subject area (the user would supply a search string such as “anthropology”, or “wifi and wimax”, employing a report creation button presented to the user in a webpage by the website 121, for example). In response, a technology overview and research report comprising all relevant research in the user specified subject area/technology area is created and presented to the user. In a related embodiment the technology overview and research report is presented in a results webpage provided by the website 121, wherein results webpage comprises one or more of the results display sections. In addition, a download option is presented to in the results webpage, wherein download is supported in PDF format, in MS Word format, in Excel format, etc. with selectively payment option included for such download or for display on the screen/website 121. In a related embodiment, a local region/country associated with the user, either determined based on user profile or based on dynamic determination of user locale (from an IP address, from a cookie used, from location of the website system 107, etc.) is employed to restrict results provided in the technology overview and research report to a geographical, regional or national scope.

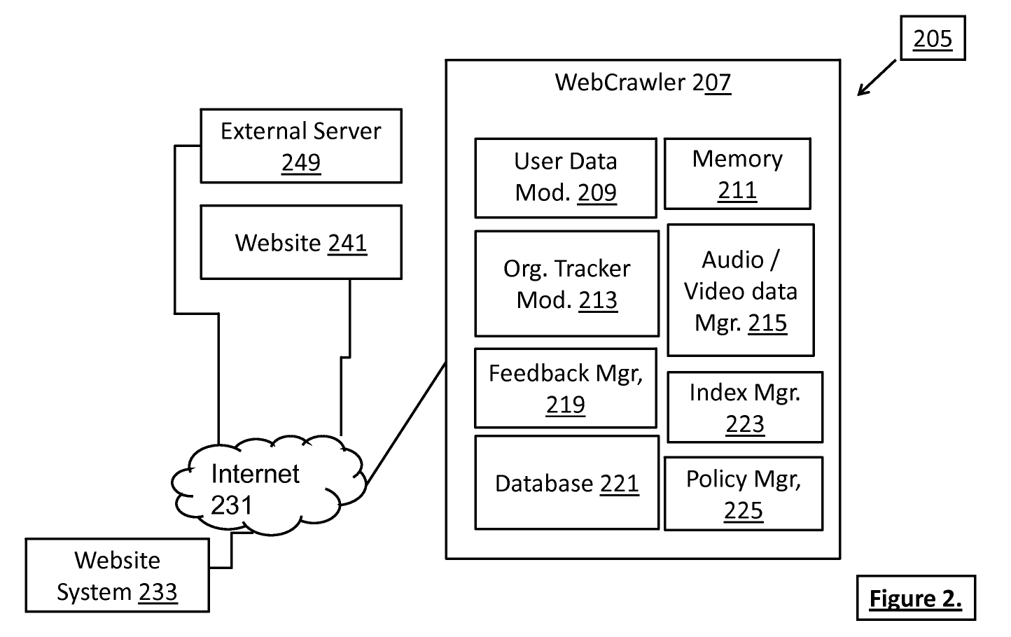

FIG. 2 is a perspective block diagram of a web crawler 207 communicative coupled to a website system 233 that collects user data from the Internet webpages as it crawls the Internet, stores it in a database 221, and facilitates creation of a resume or a user profile based on the stored data in the database 221. The web crawler 207 for the website system 233 comprises a user data module 209 that collects user data from the Internet webpages and stores it in the database 221, wherein the user data corresponds to a plurality of users/individuals, for example, encountered during crawling. The user data comprises details of a user such as contact information, education levels, transcripts, achievements information, research papers published, articles written, blogs written, software published, relationships with one or more organizations, etc. The user data also comprises audio and video recommendations, reviews and user feedback for products and services that are provided by the user, for example. The user data module 209 automatically creates a resume or a user profile for at least one of the plurality of users when requested, based at least on the user data in the database 221. In one related embodiment, the user data module 209 encounters the plurality of users in webpages retrieved in accordance with the selection policies enforced by the selection policy module of the web crawler, collects user data from the webpages and stores details of the plurality of users in a database. In a related embodiment, the user data module 209 encounters multiple items of data about a user by canning one or more webpages such as username, address, email address, identification number, social group handle, etc. and uses a combination of these (to compute a unique id or to compute a concatenated key, for example) to uniquely identify the user, and collect information about that user over time and store them in the database, and create reports when requested. In another related embodiment, the user data module 209 combines a user name, a location information (such as a zip code and street name), and other relevant pieces of data (such as email address) to create a unique identification for the user so as to be able to collect, store and retrieve data associated with a user along with data on relationships the user has had over the years with various other people and organizations, etc.

The web crawler 207 also comprises an organization tracker module 213 that collects an organization data from the Internet 231 webpages crawled and stores it in the database 221, wherein the organization data corresponds to a plurality of organizations, a memory 211, an audio/video data manager 215 that facilitates download, storage and providing access to audio and video encountered during crawling, an index manager 223 that provides an index of various webpages encountered (also provides access to a reverse index database that is part of the database 221), a feedback manager 219 (for storing user feedback and reviews for products and service, encountered during crawling or entered by users) and a policy manager 225. The organization tracker module 213 automatically creates an organization profile report for at least one of the plurality of organizations when requested, based at least on the data in the database 221. Feedback on products and services provided by a user, that is encountered while crawling websites 241 by the web crawler 207 are stored in the database 221 (or in some external server/database 249 communicatively coupled to the web crawler 207) and managed by the feedback manager 219. Various policies set for the operation of the web crawler, such as a frequency of revisits of websites, number of repeated attempts to read a webpage, the size of a URL frontier, etc. are managed by the policy manager 225.

In one embodiment, the web crawler also comprises a policy manager that helps create policies, and a selection policy module that specifies policies regarding which webpages to retrieve or download as part of crawling activity by the web crawler. It also comprises a re-visit policy module that specifies the frequencies with which changes to the webpages are checked by re-visiting corresponding websites 241 or external servers 249. A politeness policy module specifies a mechanism to avoid overloading Web sites associated with the webpages, thereby minimizing any impact on those websites. A parallelization policy module specifies a parallelization level for web crawling activities conducted by the web crawler 207.

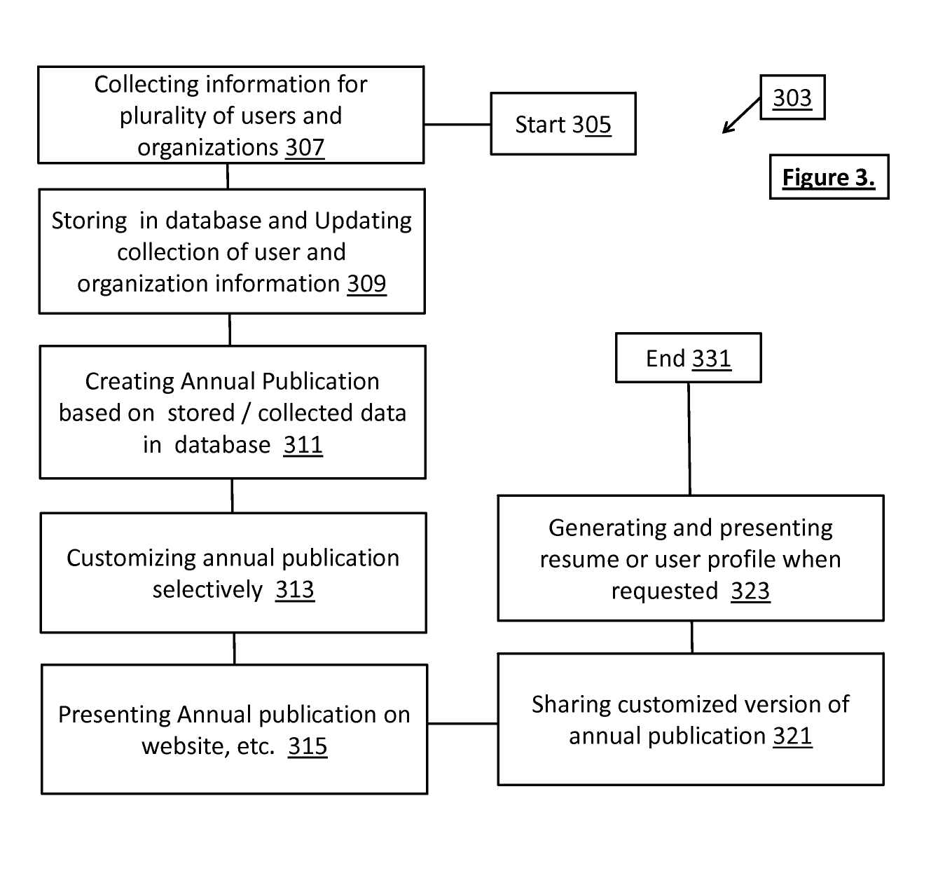

FIG. 3 is a flow chart of an exemplary operation of the website system 107 that comprises a web crawler 109 or is communicatively coupled to the web crawler 109. The processing starts at a start block 305 when the web system 107 instructs the web crawler 109 to access a URL frontier and starts accessing webpages at those URLs (or starts with a seed set). At a next block 307, the web crawler 109 collects information for a plurality of users and organizations it encounters during crawling. Thus, collecting, by the web crawler using crawling techniques and crawling across a plurality of websites and processing a plurality of webpages, results in the collection of user information for the plurality of users and the collection of organization information for a plurality of organizations. At a next block 309, the collected information is stored in the database 119. The stored database is updated, as necessary, in subsequent crawls/revisits to the same websites. Thus, the web system 107 is capable of storing and updating the collection of user information and the collection of organization information available in the database 119.

Then, at a next block 311, the web system 107 facilitates creating annual publications of various kinds, such as yearbooks, research reports for organizations, etc. Such annual publications are often based, at least in part, on the stored/collected data in the database 119. Thus, the web system 107 is responsible, for example, for creating upon a user request, an annual publication based upon the data in the database. At a next block 313, it lest a user access the annual publication and selectively (after payment of a fee, for example) customize it, save it locally and share it with friends or a group. For example, such customizing of draft annual publications may involve the user editing a yearbook created, modifying one or more contact information, adding contact information, replacing digital photos with others, adding new content, adding an index, a table of content, etc.

At a next block 315, the web system 107 facilitates presenting of the annual publication on the website 121 (or on external websites 147). It also facilitates sending the annual publication to one or more users by email. Thus, presenting the annual publication, is facilitated, for example as part of a subscription service, and may be based on a schedule.

At a next block 321, the web system 107 shares the customized version of the annual publication 321. It is done in one of several ways—by publishing it on one or more relevant pages on the website 121, by making available on a blog associated with the website 121, by making the customized version of the annual publication searchable via the search engine 125, etc. At a next block 323, when a user request a resume, the website system 107 generates one dynamically, if necessary, and presented it to the user, based on data collected in the database 119. Similarly, if the user requests a user profile (his own or that of another individual) via a webpage provided by the website 121, or via a search request received by the search engine 125 (from an external server 149, or the PC with browser 141, for example), the web system, using the data collected in the database 119 generates a user profile and presents it to the user. The operation finally terminates at the end block 331.

In one embodiment, the user request for an annual publication made by a user (from the website 121 for example) comprises a given year and a given organization. When the annual publication is one of a yearbook for the given organization identified by the user for the given year, or an annual profile for the given organization, the website system 107 has the yearbook generated and presented to the user. If, for example, the organization identified by the user is determined to provide/manufacture one or more of products or services, then, the annual information for that organization (reported by the website system 107) incorporates, services information, market share information, research information, competitive intelligence information, patents information, sales information, marketing information, legal status information, financial resources information and personnel information.

In one embodiment, customizing the annual publication created by the website system comprises selectively performing the operations, by a user, of editing, modifying, enhancing and formatting the annual publication to create a customized version of the annual publication. The user can also end up sharing the customized version of the annual publication with one or more friends/groups.

In one embodiment, collecting, by the web crawler using crawling techniques, also comprises gathering information on various subject matters and technologies and storing them in the database 119. Collecting of data facilitates subsequent generating (automatically or as triggered/scheduled) a research paper and presenting it to a user, for a given subject matter identified by a user, based on data in the database and based on information collected on the various subject matters and technologies.

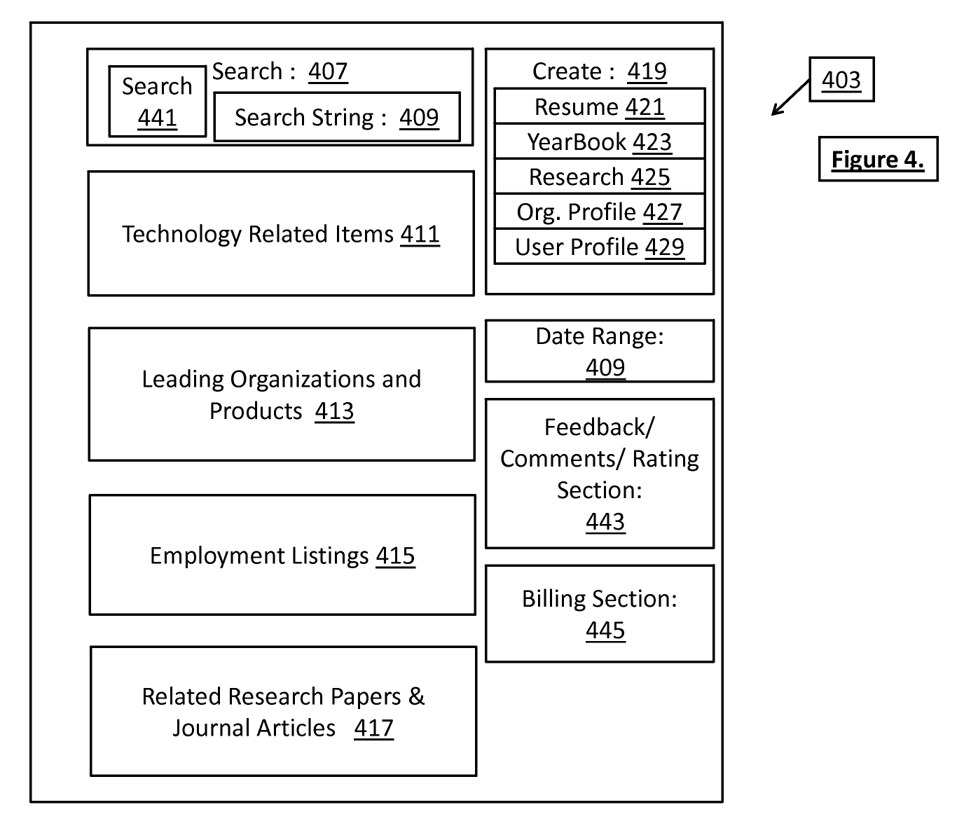

FIG. 4 is a perspective block diagram of an exemplary webpage/search screen 403 that a user employs to provide a search string, request an annual publication, a profile, a resume or a research overview, provide dates selectively, conduct a search, receive results from multiple result sets that is displayed in a combined results page. The webpage/search screen 403 provides a search criteria section 407 that prompts the user to provide a search string 409, a results creation button section 419 with multiple buttons for the creation of various kinds of annual reports etc., a data range input box for selective/optional date range specification (default being last 1 year, for example) and one or more results display sections 411, 413, 415, 417 for partial result set presentation for results set data organized under multiple sets. The activation of the Search button 441 triggers the retrieval and display of content in the results display sections 411, 413, 415, 417.

In one embodiment of the present invention, the results display sections comprise a technology related items section 411 for displaying a list of related technologies, a leading organizations and products section 413, the employment listings section 415 and a related research papers & journal articles section 417, all based on the search string 409 provided by the user. The technology related items 411 displays details of any technology/sciences where the terms of the search string are commonly found or ranked higher. The leading organizations and products section 413 provides a list of all organizations and products that correspond to the search terms provided by the user. This includes companies that create/market/manufacture these products or services, and marketing literature, brochures, user feedback, etc, for those products and services.

The employment listings 415 section provides a list of jobs available, locally or nationally (or even internationally based on policies) that are related to the search string 409 terms, and to other criteria that may be determined by the website system 107 (such as location of user, employment history of user, etc.). The related research papers & journal articles section 417 provides information on latest research for the topics associated with the search terms. This would also include articles from journals, trade magazines, blogs, scientific journals, etc.

The results creation button section 419 comprises a Resume button 421, a YearBook button 423, a Research button 425, an organization profile button 417 and a user profile button 429. The use of additional buttons for other kinds of reports is also contemplated. Each of these buttons trigger the generation and retrieval of an appropriate kind of report, in one embodiment. The use of these buttons are optional. The activation of the Search button 441 triggers the retrieval and display of content in the results display sections 411, 413, 415, 417 when the user desires default search behavior. Otherwise, the user can select any one of the buttons (other forms of user interactions are also contemplated for this section, such as menu items, drop down selection lists, etc.) in the results creation button section 419 and a corresponding report is retrieved/generated and presented to the user. For example, if the user profile button 429 is activated by the user, it triggers the retrieval/generation of a user profile report based on the search string provides 409, wherein the search string is assumed to comprise an user identification, such as a user name or a social-security number, etc.

In one embodiment, the results creation button section 419 comprises buttons to create a yearbook for a corporation wherein the yearbook comprises summary of or references to all research papers and technical documents published (or URLs of websites, ISBN numbers, titles, etc. to such research papers and technical documents), all patents filed for and acquired, details of personnel changes, market share information, products and services introduced into market, products and services terminated, etc.

In another embodiment, the results creation button section 419 comprises buttons to create a technology overview with recent updates and research information in the field for a user specified technology/subject area (the user would supply a search string such as “anthropology”, or “wifi and wimax”). In response, a research report comprising all relevant research in the user specified subject area/technology area is created and presented to the user, employing one or more of the results display sections 411, 413, 415, 417. In addition, a download of the research report in PDF format, in MS Word format, in Excel format, etc. is provided for optional download by a user, selectively involving payment by user for such download or for display on the screen, etc. (if need be). In a related embodiment, a local region/country associated with the user, either determined based on user profile or based on dynamic determination of user locale (from an IP address, from a cookie used, from location of a server, etc.) is employed to restrict results provided in the research report to a geographical, regional or national scope.

In one embodiment, the webpage/search screen 403 provides a feedback/comments/rating section 443 that provides buttons (audio record button, like/dislike buttons ratings buttons, etc.) and text input fields (such as a field for comments) to allow a user to provide feedback, such as “like”/“dislike” rating, textual comments, audio comments, etc. In a related embodiment, the feedback/comments/rating section 443 provides one or more of a rating feedback, a preference feedback, an audio feedback, a video feedback, an image feedback, and a text feedback features/buttons. It also presents the user with a billing section 445 that the user can use to provide billing information in order to purchase a report, download a research report, conduct a search, etc. For example, the billing section 445 provides a field for user account identification, paypal or similar payment service access buttons, optional credit card data input fields, etc.

In one embodiment, the webpage/search screen 403 provides buttons to create a distribution list for the report generated with the search results, such as a distribution list (comprising one or more recipients) for distribution of an annual publication such as a yearbook.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The terms “audio preamble” and “voice preamble” as used herein may refer to recorded voice inputs that a user records, to provide a question/prompt in human language, that also selectively incorporates responses in multiple choice format to aid selection by a recipient. The audio preamble may be captured by a mobile device in MP3 format, AMR format, WMA format, etc.

The term “report” as used herein may refer to a assembled document (html based, text based, xml based, PDF based, etc.) produced that may comprise several sections, each section comprising one or more entries with text, optional image, optional audio portions, optional video segment, etc. Each section may also comprise video supplementary information, audio supplementary information, etc. that makes it possible for a recipient to read, view and listen to several different aspects of an entry in that section. When the user is presented the report on a mobile device or tablet, its presentation is altered to make it more useable, with the website system 107 providing for such flexibility.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A website system, the website system comprising:
a web crawler that crawls webpages starting with seed URLs, and crawls links and references contained in those webpages, and gathers a URL frontier;
the web crawler visits the URLs from the URL frontier recursively according to a set of policies and gathers a crawled data, wherein the crawled data also comprises information about one or more entities encountered or referenced in the webpages crawled;
a relationship tracker module that creates a network of relationships from the crawled data and tracks relationships between the one or more entities;
the relationship tracker module determining the dates of relationships, duration of those relationships, the category and type of those relationships and storing them as searchable data in a database in the website system;
an entity tracker module that collects and tracks details of the one or more entities, the details comprising activities associated with the one or more entities, and modifications to those details over time, and stores them in the database; and
the website system, when triggered, providing a report related to one of the one or more entities, a report of relationships over time for a given entity among the one or more entities, or a report of activities associated with the given entity specified.

2. The website system of claim 1 further comprising:
the one or more entities comprising an organization;
the entity tracker module collects and tracks details of the organization, the details comprising activities associated with the organization, and modifications to the details of the organization; and
the website system, when triggered, providing a report of details of the organization and relationships over time for the organization with some of the other entities.

3. The website system of claim 1 further comprising:
the one or more entities comprising references to one or more organizations and at least one person;
the entity tracker module collects and tracks details of the one or more organizations and the person, and modifications to the details of the one or more organizations and the at least one person; and
the website system, when triggered, providing a resume report of relationships over time for one of the at least one person with at least one of the one or more organizations.

4. The website system of claim 1 further comprising:
the website system providing a search interface that facilitates search and retrieval of data collected and managed by the relationship tracker module and the entity tracker module.

5. The website system of claim 1 further comprising:
the one or more entities comprising identification of and references to one or more people and one or more organizations; and
a dynamic publication creator module that dynamically creates an annual publication providing a people information, an events information, an activities information and related data for a given year in a target organization among the one or more organizations, based at least partially on the data in the database.

6. The website system of claim 5 further comprising:
the website system, upon receiving a request that specifies the given year and the target organization, creates an annual publication employing the dynamic publication creator module and presents it and communicates it employing webpages and email as necessary.

7. The website system of claim 6 wherein the annual publication is a yearbook and wherein the website system selectively charges fees for presenting or communicating the annual publication.

8. The website system of claim 1 wherein the one or more entities comprises one or more educational institutions and one or more individuals who are students in those educational institutions, and wherein the report of relationships over time is a yearbook for the one or more individuals.

9. The website system of claim 2 wherein the one or more entities comprises one or more commercial or business organizations, and one or more individuals who were, at some point, employees or workers in those one or more commercial or business organizations.

10. The website system of claim 1 wherein the report of relationships over time that also comprises activities over time, based on data in the database, is appropriately presented, as relevant, as a webpage or an email, and is organized as one of a resume, a newsletter published by an educational institution, a bibliography, a newspaper, a publication from a school district, a product review, a sports statistics publication, a research paper on a topic, and a student graduation related document.

11. The website system of claim 1 further comprising:
the entity tracker module also collects and tracks documents associated with the one or more entities and stores references to those documents; and
the report created by the website system incorporates at least a portion of the documents or references to the documents.

12. The website system of claim 5 wherein the annual publication is a yearbook for a school, for a corporation, for a business or for a social group.

13. The website system of claim 5 wherein the annual publication is a profile of at least one of the one or more organizations for a given year.

14. The website system of claim 1 wherein the one or more entities comprises one or more individuals and one or more organizations, the website system further comprising:
a search engine that uses the web crawler to collect information on the one or more individuals and the one or more organizations; and
the website system comprising a website that provides webpages to permit users on the Internet to enter a search term in order to retrieve details regarding the at least one of the one or more individuals or the one or more organizations.

15. The website system of claim 1, wherein the one or more entities comprises one or more individuals, the website system further comprising:
the website system providing an interface to automatically create a resume or a user profile based on the crawled data and the data in the database, for at least one of the one or more individuals.

16. A web crawler for a website system, the web crawler comprising:
the web crawler crawling through Internet webpages;
a user data module that collects user data from the Internet webpages and stores it in a database, wherein the user data corresponds to a plurality of users; and
the user data module automatically creating a resume or a user profile for at least one of the plurality of users when requested, based at least on the user data in the database.

17. The web crawler of claim 16 further comprising:
an organization tracker module that collects an org data from the Internet webpages and stores it in the database, wherein the org data corresponds to a plurality of organizations; and
the organization tracker module automatically creating a organization profile report for at least one of the plurality of organizations when requested, based at least on the data in the database.

18. The web crawler of claim 16 wherein the user data also comprises textual, audio and video recommendations and user reviews and feedback for products and services provided by the plurality of users.

19. The web crawler of claim 16 further comprising:
a selection policy module that specifies policies regarding which webpages to retrieve or download as part of the crawling activity by the web crawler; and
the user data module encountering the plurality of users in webpages retrieved in accordance with the selection policies enforced by the selection policy module, collecting user data from the webpages and storing details of the plurality of users in the database.

20. A method of operating a web system, the method comprising:
collecting, by the web system that comprises a web crawler or is communicatively coupled to the web crawler, using crawling techniques and crawling across a plurality of websites and processing a plurality of webpages, a collection of user information for a plurality of users and a collection of organization information for a plurality of organizations;
storing and updating the collection of user information and the collection of organization information in a database;
creating, upon a user request, an annual publication based upon the data in the database; and
presenting the annual publication employing webpages or employing email.

21. The method of claim 20 wherein the user request comprises a report type, a given year and a given organization and wherein the annual publication is, based on the report type, one of a yearbook for the given organization for the given year or an annual profile for the given organization that comprises one or more of products information, services information, market share information, research information, competitive intelligence information, patents information, sales information, marketing information, legal status information, financial resources information and personnel information.

22. The method of claim 21 further comprising:
customizing the annual publication created by editing, modifying, enhancing and formatting the annual publication to create a customized version of the annual publication; and
sharing the customized version of the annual publication with one or more friends.

23. The method of claim 20 wherein collecting, by the web crawler using crawling techniques, also comprising gathering information on various subject matters and technologies, the method further comprising:
generating automatically a research paper and presenting to a user, for a given subject matter identified by a user, based on data in the database and based on information collected on the various subject matters and technologies during crawling.

24. The system of claim 19 wherein the user feedback to the presented report comprises at least one of a rating feedback, a preference feedback, an audio feedback, a video feedback, an image feedback, and a text feedback.
